(19) United States
(12) Patent Application Publication
(10) Pub. No.: US 2012/0030696 A1
(43) Pub. Date: Feb. 2, 2012

(54) Spatially Constrained Biosensory Measurements Used to Decode Specific Physiological States and User Responses Induced by Marketing Media and Interactive Experiences

(76) Inventor: W. Bryan Smith, Berkeley, CA (US)

(21) Appl. No.: 13/053,097

(22) Filed: Mar. 21, 2011

Related U.S. Application Data
(60) Provisional application No. 61/315,927, filed on Mar. 20, 2010.

(51) Int. Cl. H04H 60/33

(52) U.S. Cl. 725/10

(57) ABSTRACT

Embodiments described herein include a method running on a processor for decoding user response to marketing media, the method comprising: defining calibration stimuli that produce at least one expected response; defining data features for assessing one or more states of a plurality of users using at least one of the calibration stimuli and the at least one expected response; identifying a set of data features based on a first correlation between the set of data features and the at least one expected response; and iteratively reducing the set of data features based upon an amount of variation explained by the reduced set of data features and a second correlation between the reduced set of data features and the at least one expected response.

### RELATED APPLICATION

This application claims the benefit of U.S. Patent Application No. 61/315,927, filed Mar. 20, 2010.

This application is related to the following U.S. patent application Ser. Nos. 11/804,517, filed May 17, 2007; 11/804,555, filed May 17, 2007; 11/779,814, filed Jul. 18, 2007; 11/500,678, filed Aug. 8, 2006; 11/845,993, filed Aug. 28, 2007; 11/835,634, filed Aug. 8, 2007; 11/846,068, filed Aug. 28, 2007; 12/180,510, filed Jul. 25, 2008; 12/206,676, filed Sep. 8, 2008; 12/206,700, filed Sep. 8, 2008; 12/206,702, filed Sep. 8, 2008; 12/244,737, filed Oct. 2, 2008; 12/244,748, filed Oct. 2, 2008; 12/263,331, filed Oct. 31, 2008; 12/244,751, filed Oct. 2, 2008; 12/244,752, filed Oct. 2, 2008; 12/263,350, filed Oct. 31, 2008; 11/430,555, filed May 9, 2006; 11/681,265, filed Mar. 2, 2007; 11/852,189, filed Sep. 7, 2007; 11/959,399, filed Dec. 18, 2007; 12/326,016, filed Dec. 1, 2008; 61/225,186, filed Jul. 13, 2009.

### TECHNICAL FIELD

The following disclosure relates generally to the collection and processing of data relating to bio-sensory metrics.

### BACKGROUND

Conventional Electroencephalography (EEG) methodology uses a cap that covers the entire scalp with recording electrodes. Using this approach, an experimenter generates a map of the entire brain over time, and then mines this map for information relevant to the task being performed by the subject.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE DRAWINGS

FIG. 1 is a flow diagram for predictive modeling for measuring the impact of marketing media and interactive user experiences on consumer behavior, under an embodiment.

FIG. 2 is a flow diagram for expert model refinement, under an embodiment.

FIG. 3 is a block diagram of the process of reducing a very high dimensional dataset based on dimensionality reduction and correlation to priors, under an embodiment.

FIG. 4 is a diagram of a system for measuring the physiological responses of individuals to test media, under an embodiment.

### DETAILED DESCRIPTION

Systems and methods described herein use EEG sensors targeted to specific regions on the head, where brain states and subject responses are recorded that are relevant to marketing media and interactive user experiences in a spatially specific way. The algorithms described are computed independent of pre-designated frequency bands (e.g., delta, theta, alpha, gamma, etc). Rather, relevant frequency bands are but one of a plurality of data features, each of which is defined using a calibration procedure that is directly relevant to the specific brain states and responses being recorded.

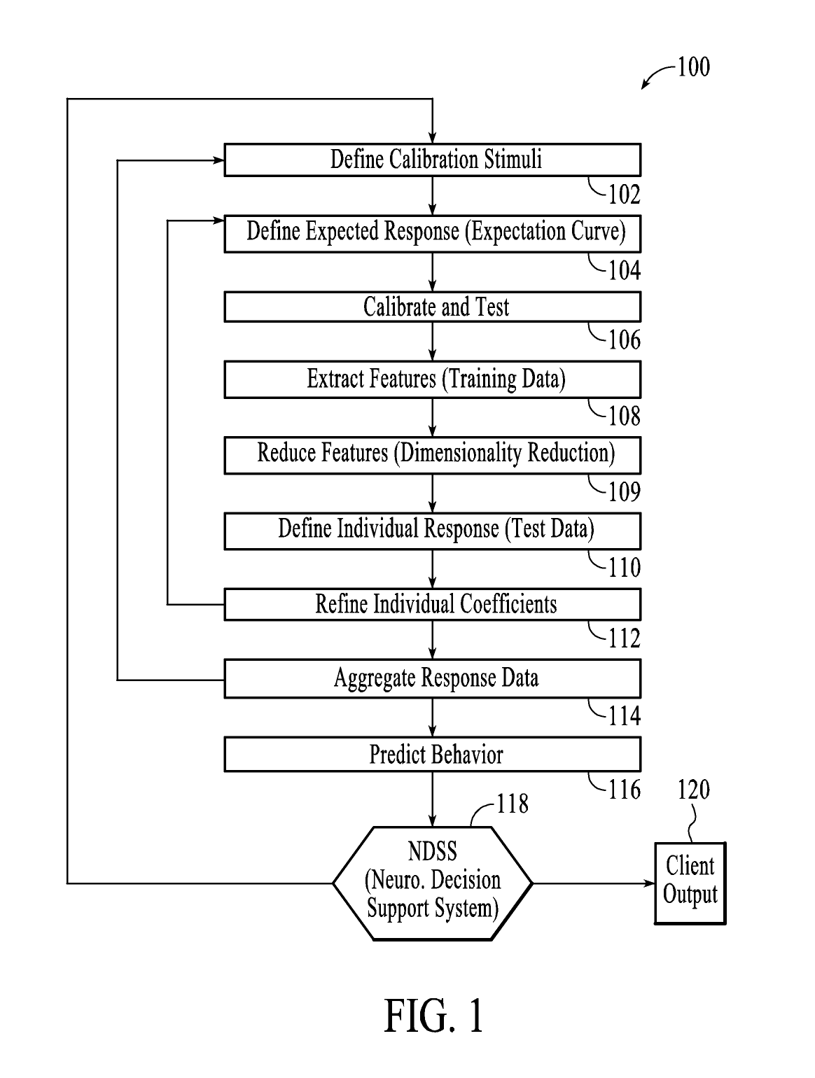

FIG. 1 is a flow diagram for predictive modeling for measuring the impact of marketing media and interactive user experiences on consumer behavior, under an embodiment. The overall flow for the Predictive Data Model is shown at left, with feedback loops that use refined model coefficients from individual test subjects 112 to update expected response functions 104, and aggregate response data 114 to update and potentially redefine calibration stimuli 102 as appropriate. The output 120 of the data model drives the Neuroscience Decision Support System 118 (NDSS), which both provides valuable output information 120 to clients, as well as feeding back into the Data Model to improve the accuracy and relevance of the Data Model for client-driven research needs.

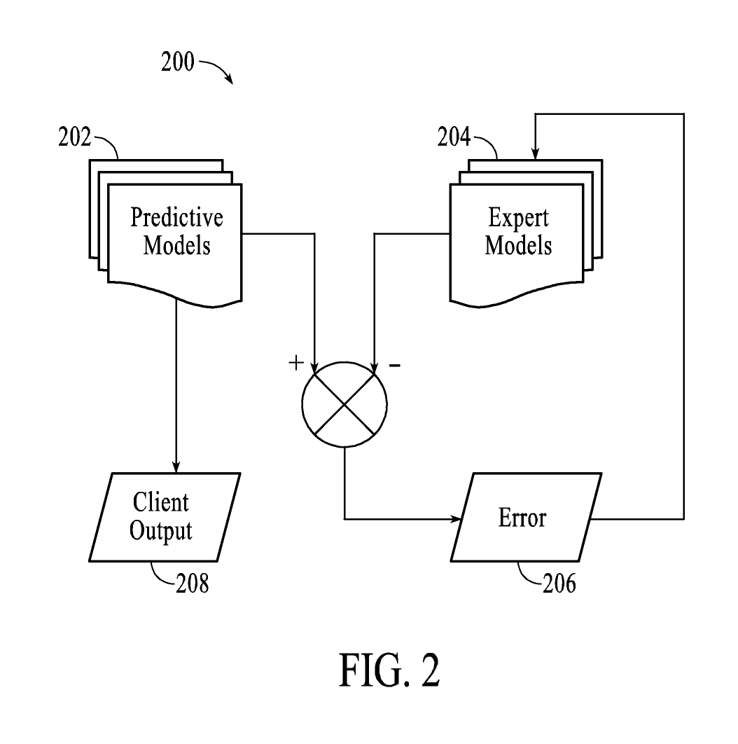

FIG. 2 is a flow diagram for expert model refinement, under an embodiment. The results of Predictive Models 202 (output of EmSense algorithms) and Expert Models 204 (client internal models as well as EmSense models), are summed, generating an Error function 206 that can be used to evaluate, refine, and improve client understanding and value of their expert systems models.

The embodiments described herein generally comprise a method where relevant data features for each state or response measurement are defined from the population data. Generally, an embodiment uses dimensionality reduction algorithms to reduce defined data features into a smaller feature space. The embodiment then uses refinement procedures (e.g., least-squares fitting to “priors,” etc.) to adjust coefficients associated with features for individuals. Metrics for individuals are computed using refined coefficients. The embodiment then aggregates by computing an average of metrics across the population for analysis.

An embodiment includes expectation curves 104 (priors) that are based on data/survey/experts, and the expectation curves 104 are used as a template for defining features. The training dataset 108 is the calibration media, as distinguished from the testing dataset which is being evaluated in any particular test. Therefore, if an expectation curve 104 indicates an image of a baby should make some positive-going curve, an embodiment uses that information to extract features 108 in a feature selection stage to rule in (or out) features that do (or do not) correlate with the shape of that expectation curve 104. In this example, the image of the baby is training data, and the positive-going curve is the expectation (prior).

Media and experiences (referred to herein as “experiences”) include, but are not limited to, television commercials, print ads, web-based ads, website navigation, web-based shopping, virtual in-store shopping, and live in-store shopping. The method employs a data mining approach based on the integration of a variety of measurement modalities including industry-relevant expert opinion, electroencephalography (EEG), blood volume, heart data, head movement, body movement, eye movement and pupil dynamics, eye blinks, and survey responses. From this set of measurements, or an arbitrary mathematical combination of any of them, the subject's experience is defined.

To take into account individual test subject variability, calibration of the biosensory-derived states and responses of each individual subject is performed using a set of proprietary calibration stimuli 102 including sounds, still images, videos, and other test-relevant media. Under an embodiment, unique sets of calibration stimuli 102 are used for specific test types to ensure the calibration procedure does not bias the tester's response to the actual test stimuli. For example, if the test involves the subjects evaluating ads for baby care products, the calibration stimuli 102 do not contain images of babies or anything else that can be directly determined to bias or otherwise interfere with the subject's responses during the test phase. An example set of calibration stimuli 102 for an advertisement could be a set of “training” ads that may or may not include ads of competing products, products in entirely different categories, etc. From scenes in these ads, which are NOT being evaluated in the present study, each tester's responses can be calibrated. An example set of calibration stimuli 102 for a package test could include package images of competing products, package images of products in different categories, images from a database (e.g., EmSense Corporation database) that have been previously determined to evoke consistent emotional or cognitive responses across testers, etc. An example set of calibration images for an in-store shopping test might comprise package images, images of competing stores, etc. The calibration stimuli 102 may be displayed to the subject at the beginning and/or at the end of the test media or experiences being evaluated.

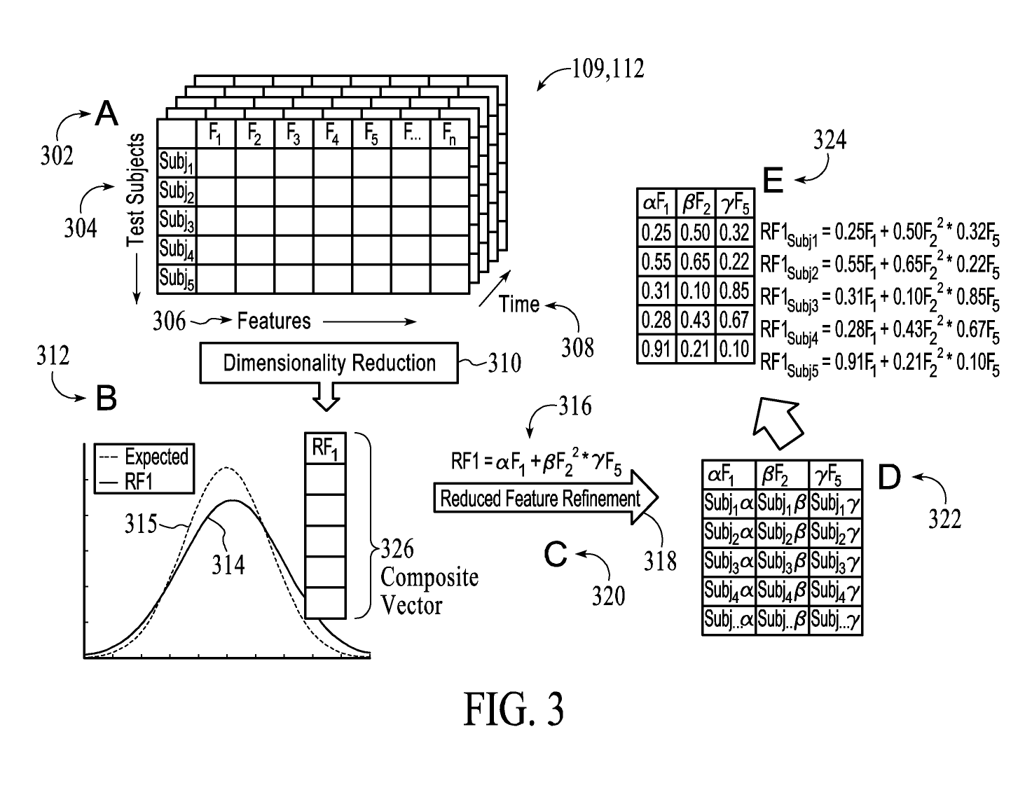

The calibration stimuli 102 also provide a set of “expected” responses 104 that may further be used to define data features as described below. There may be an image that is known, on average, to evoke a very positive emotional response in subjects, one that evokes a very negative emotional response, etc. The expectations 104 are determined empirically, using population data, previous tester data from the EmSense database, via surveys of each individual test subject, and as an additional novel claim, by expert opinions of partners and clients in the industry relevant to the test being conducted. An embodiment defines data features relative to brain states or responses of interest using a calibration and testing procedure 106 that extracts features 108 in a feature selection stage to rule in (or out) features that do (or do not) correlate with expected responses 104. As set forth in FIG. 3 (and further described below), the data acquired during the calibration phase of each experiment serve as a “training” dataset for dimensionality reduction and data mining algorithms used to define/extract relevant data features 108 for determining the test subject's state and/or responses to the experience. The number of test subjects 304 determines the rows of a matrix, while the features 306 from which reduced data representations are computed define the columns. By convention, matrix dimensions are defined using the [m, n, p, . . . ] notation, where m is the number of rows, n the number of columns, p, . . . for the third and any higher dimensions. For example, a dataset in which 150 features are measured on 300 testers would be represented as a [300,150] matrix of observations. In an example case where 25 calibration stimuli are used, the dataset would be a size [300,150,25] 3-D matrix.

The set of raw features 306 used in the first-pass dimensionality reduction 310 stage of the analysis include the following: time domain features of EEG, heartbeat, eye movement, eye blink, and body movement data (such as mean, minimum, maximum amplitude in a specified interval, time to min or max amplitude, etc); frequency domain features of EEG, heartbeat, eye movement, eye blink, and body movement data (such as mean, minimum, maximum, mode of frequency in a specified interval, time to minimum or maximum, ratios of arbitrary numbers of arbitrarily-defined frequency bins, sums of arbitrary numbers of arbitrarily-defined frequency bins, differences of arbitrary numbers of arbitrarily-defined frequency bins, products of arbitrary numbers of arbitrarily-defined frequency bins, etc); time and frequency domain features of pupil dynamics; event-related potentials; phase relationships (including coherence), and any commonly-computed linear or nonlinear composite representation of these features or combinations thereof.

Some example composite vectors 326 are defined here. These are examples that illustrate the point of how features may be combined, and are not intended to limit the combinations of data features that might be used to define any relevant vectors. A vector of an embodiment that indicates visual attention comprises a low eye blink rate and increased EEG activity in the occipital lobe (at the back of the brain). An Affective Valence vector (emotional state) of an embodiment comprises some combination of heart rate, eye blink rate, and prefrontal EEG content. A composite feature vector that defines “shopper frustration” of an embodiment can be formulated using Boolean logic in the following way: If Cognitive Load is high, and Affective Valence is low for at least half a second while evaluating a package, the Frustration index is high.

Dimensionality reduction 310 of an embodiment is defined as collapsing the large number of features into a smaller, potentially composite (mathematically combined in some linear or nonlinear way) feature space. Specifically, in dimensionality reduction algorithms such as Principal Components Analysis (PCA), the reduced data representation is computed such that each principal component progressively captures less and less of the variance in the dataset (i.e. the first component may explain 30% of the variance, the second component 22%, etc). In the process of an embodiment, the reduction process takes into account not only the variance described by the reduced feature space, but feature selection also takes into account the correlation of the reduced features with the previously defined expectations of the responses, as defined above (see graph in FIG. 3).

FIG. 3 is a block diagram of the process of reducing a very high dimensional dataset based on dimensionality reduction 310 and correlation to priors 312, under an embodiment. The data representation is shown in A 302, where test subjects 304 are represented in the rows of the matrix (from 1 to m), data features 306 are across the columns (from 1 to n), and time 308 is shown in the z-axis, into the depth of the page. This representation is an example, and any of the dimensions may be swapped in practice (i.e. time may go down the rows, with subjects into the page, etc). In B 312, the “best fit” reduced representation of the data 314 (RF1, solid line) is shown correlating with the expected (prior) response 315 (dashed line). Through iterative feature refinement 318, the coefficients (a, (3, and y) associated with the three parameters in RF1 (F1, F2, and F5), are refined for each individual test subject as shown in D 322. In E 324 is shown an actual example of what those individual coefficients could look like, and how each test subject's RF1 function would be represented.

As an example, a particular calibration image, such as a picture of a smiling baby, is expected to elicit a positive emotional response. The high-dimensional feature matrix 302 is mathematically transformed into a reduced representation of the data subject to two conditions: (1) The reduced features capture a majority of the variance in fewer dimensions than the original data, and (2), The reduced features show a high degree of correlation with the expected response (in this case a positive-going curve that represents a positive emotional response to the picture of the baby). This process may be performed iteratively, where dimensionality reduction methods (including, but not limited to, PCA, Linear Discriminant Analysis, Support Vector Machines, Locally Linear Embedding, etc) are first applied, and then the correlation coefficient is measured between the reduced vectors and the expectation curve, going back through another round of dimensionality reduction and recomputing the correlation coefficient, etc. Through such an iterative feature selection process, it may be determined that a nonlinearly-weighted composite vector of data features 1, 2 and 5 (which in this example could be EEG, heart rate, and eye blink rate, but in reality can be any feature or mathematically-computed combination of features) defines the best correlate of the expected positive response to that calibration stimulus across the group of test subjects (see FIG. 3). The nonlinear weighting function used to determine the correlation in this example case would then be applied to all the data for each subject, and the resulting dataset would represent the positive emotional response vectors for the entire test. The process is then repeated for every vector of interest in the study.

In an attempt to further model and understand the variability of subject responses, the reduced feature representation function 316 that is derived from the entire set of test subjects may be refined on an individual subject basis. Taking the aforementioned example of a nonlinear function that correlates with an expected positive emotional response, the coefficients associated with the terms of that nonlinear model may be refined and adjusted on each individual tester under a reduced feature refinement process 318 that attempts to minimize across-subject variance of the expected responses. This coefficient refinement process can be accomplished using a variety of standard statistical methods including, but not limited to, minimizing mean-squared error between the reduced data representation and the expectation function, nonlinear least-squares fitting, ridge regression, etc. As an example, even though it may be the case that the combination of EEG, heart rate, and eye blink rate defines the most reliable correlate of positive emotional state across all subjects in a given study, the specific coefficients assigned to each of those variables may be individually defined: some individuals may show larger changes in EEG frequency whereas others may show larger changes in heart rate for the same stimulus. These differences can be computed for every individual in any given test, can be incorporated into the model when computing aggregate responses, and will generally improve the accuracy of the state and response predictions when applied to the test data.

These accurate state and response predictions that incorporate large test subject populations and expert opinions are ultimately fed into a Neuroscience-based decision support system 118 (NDSS). This NDSS is a computational database that delivers key insights and knowledge to market research and product design teams (clients), as well as feeding back into the data model to improve data model performance over time. When integrated with real-world sales tracking and market-share sales data from clients and other resources, this feedback system can be further mined to identify components within the EmSense database that correlate with macroeconomic indicators, market trends, and other emergent long-term macroscopic features that add predictive value to EmSense partners and clients.

An additional feature of the integrated data model and NDSS is the ability of such a system to learn over time how the expert models of clients and partners perform relative to both the EmSense test data as well as the real-world market results. By summing the output 208 of the NDSS and the expert information 204 obtained from clients and partners, various experts can be scored and their opinions and recommendations can be evaluated and monitored over time. Such a system provides valuable information to clients as partners, increasing the confidence in reliance on various experts in specific research contexts. Consider an example situation, in which group package design experts in a consumer packaged-goods company develop a new package that, for various reasons, they believe will improve consumer response to the package by 5%. Through the proprietary EmSense testing structure, integrated with tracking of sales and market share data over time, the validity of the expert's claims can be validated (or refuted), thereby increasing (or decreasing) the confidence in those experts over time.

The embodiments described herein comprise a method for incorporating expert opinions, prior EmSense Corporation test results, and within-test user survey responses to define expectation curves (“priors”) to the calibration stimuli.

The embodiments described herein comprise a method for calibrating subjects, before and/or after the actual test, that does not influence the test stimuli being evaluated.

The embodiments described herein comprise a method using features from the calibrations to measure Affective Valence at prefrontal lobe sites.

The embodiments described herein comprise a method using features from the calibrations to measure Cognitive Load at prefrontal lobe sites.

The embodiments described herein comprise a method using features from the calibrations to measure Memory Encoding at temporal lobe sites.

The embodiments described herein comprise a method using features from the calibrations to measure Visual Attention at occipital lobe sites.

The embodiments described herein comprise a method using features from the calibrations to measure Emotional Memory as an interaction between prefrontal and temporal lobe sites.

The embodiments described herein comprise a method using features from the calibrations to measure Visual Memory encoding as an interaction between occipital and temporal lobe sites.

The embodiments described herein comprise a method using any combination of Affective Valence, Cognitive Load, Memory Encoding, Visual Attention, Emotional Memory, and Visual Memory Encoding for relevant brain states or responses.

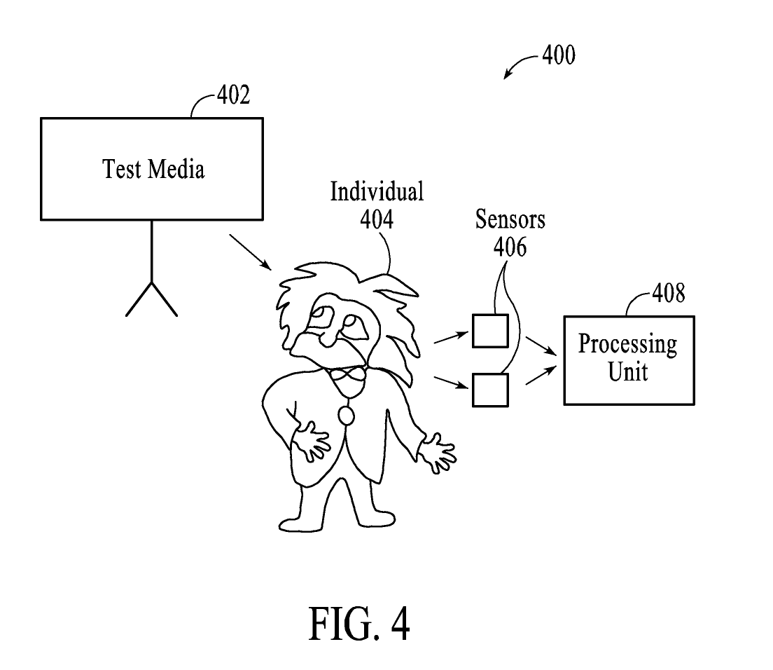

In the embodiment of FIG. 4, a the system 400 includes test media 402, individual 404, sensors 406, and processing component 408. As depicted, individual 404 is stimulated by test media 402 while having the physiological responses of individual 404 monitored by processing component 408 using sensors 406. Here the test media can be one or more of television commercials, print ads, web-based ads, website navigation, web-based shopping, virtual in-store shopping, and live in-store shopping, and any other media which could stimulate an individual. Sensors 406 could be one or more of an accelerometer, a blood oxygen sensor, a galvanometer, an electroencephalogram, an electromygraph, and any other physiological sensor.

Embodiments described herein include a method running on a processor for decoding user response to marketing media. The method of an embodiment comprises defining calibration stimuli that produce at least one expected response. The method of an embodiment comprises defining data features for assessing one or more states of a plurality of users using at least one of the calibration stimuli and the at least one expected response. The method of an embodiment comprises identifying a set of data features based on a first correlation between the set of data features and the at least one expected response. The method of an embodiment comprises iteratively reducing the set of data features based upon an amount of variation explained by the reduced set of data features and a second correlation between the reduced set of data features and the at least one expected response.

Embodiments described herein include a method running on a processor for decoding user response to marketing media, the method comprising: defining calibration stimuli that produce at least one expected response; defining data features for assessing one or more states of a plurality of users using at least one of the calibration stimuli and the at least one expected response; identifying a set of data features based on a first correlation between the set of data features and the at least one expected response; and iteratively reducing the set of data features based upon an amount of variation explained by the reduced set of data features and a second correlation between the reduced set of data features and the at least one expected response.

The method of an embodiment comprises testing responses of each user of the plurality of users to testing media, the one or more states of the plurality of users including the responses.

The method of an embodiment comprises determining coefficients of each data feature of the reduced set of data features through the testing.

The testing media of an embodiment includes television commercials, print ads, web-based ads, website navigation, web-based shopping, virtual in-store shopping, and live in-store shopping.

The calibration stimuli of an embodiment include sounds, still images, videos and other media relevant to the testing media.

The method of an embodiment comprises refining the coefficients for each user of the plurality of users.

The refining of an embodiment includes the application of one or more statistical methods, the one more statistical methods using information including responses of the plurality of users to at least one of the calibration stimuli and the testing media.

The one or more statistical methods of an embodiment includes mean squared error analysis.

The one or more statistical methods of an embodiment includes non-linear least squares fitting.

The one or more statistical methods of an embodiment includes ridge regression.

The method of an embodiment comprises using the refined coefficients to update the at least one expected response.

The method of an embodiment comprises computing an aggregate response to the testing media across all users of the plurality of users, the aggregate response including information of at least one of the coefficients and the revised coefficients.

The method of an embodiment comprises using the aggregate response to update the calibration stimuli.

Expected responses to the calibration stimuli of an embodiment are empirically determined using at least one of population data, previous test data, surveys of the plurality of users, and expert opinions from an industry relevant to the testing.

The expected responses of an embodiment includes the at least one expected response.

The method of an embodiment comprises using training media to assess and minimize bias in the responses of the plurality of users to the testing media by analyzing responses of the plurality of users to the training media, the training media including the calibration stimuli.

The training media of an embodiment includes media analogous to the testing media but not used as the testing media, the training media including the calibration stimuli.

The training media of an embodiment are presented to the plurality of users before the testing.

The training media of an embodiment are presented to the plurality of users after the testing.

The method of an embodiment comprises explaining the amount of variation.

The explaining of an embodiment includes using Principle Component Analysis.

The explaining of an embodiment includes using Linear Discriminant Analysis.

The explaining of an embodiment includes using Support Vector Machines.

The explaining of an embodiment includes using Locally Linear Embedding.

The data features of an embodiment comprise time domain features including EEG data, heartbeat data, eye movement data, eye blink data, and body movement data.

Collecting time domain features of an embodiment comprises measuring one or more of mean, minimum, and maximum amplitude of at least one of the time domain features in a specified interval and time to minimum or maximum amplitude of at least one of the time domain features.

The data features of an embodiment comprise frequency domain features of EEG, heartbeat, eye movement, eye blink, and body movement data.

Collecting frequency domain features of an embodiment comprises measuring one or more of mean, minimum, maximum, mode of frequency in a specified interval, time to minimum or maximum, ratios of arbitrary numbers of arbitrarily-defined frequency bins, sums of arbitrary numbers of arbitrarily-defined frequency bins, differences of arbitrary numbers of arbitrarily-defined frequency bins and products of arbitrary numbers of arbitrarily-defined frequency bins.

The method of an embodiment comprises inputting state and response predictions generated by the testing process into a Neuroscience-based decision support system (NSDSS), wherein the testing process comprises one or more of the defining calibration stimuli, the defining the data features, the identifying the set of data features, the iteratively reducing the set of date features, the testing, the determining the coefficients, the refining the coefficients, and the computing an aggregate response.

The NSDSS of an embodiment provides market research and product design metrics and iteratively provides information to the testing process that improves predictive performance of the testing process.

The method of an embodiment comprises combining the state and response predictions with expert information to generate an error function used to provide performance metrics for the testing process, wherein the expert information includes proprietary information of at least one of the provider of the testing process and the party commissioning the testing process.

Embodiments described herein include a machine-readable medium including executable instructions which, when executed in a processing system, decodes user response to marketing media by: defining calibration stimuli that produce at least one expected response; defining data features for assessing one or more states of a plurality of users using at least one of the calibration stimuli and the at least one expected response; identifying a set of data features based on a first correlation between the set of data features and the at least one expected response; and iteratively reducing the set of data features based upon an amount of variation explained by the reduced set of data features and a second correlation between the reduced set of data features and the at least one expected response.

The machine-readable medium of an embodiment comprises testing responses of each user of the plurality of users to testing media, the one or more states of the plurality of users including the responses.

The machine-readable medium of an embodiment determines coefficients of each data feature of the reduced set of data features through the testing.

The testing media include television commercials, print ads, web-based ads, website navigation, web-based shopping, virtual in-store shopping, and live in-store shopping.

The calibration stimuli includes sounds, still images, videos and other media relevant to the testing media.

The machine-readable medium of an embodiment refines the coefficients for each user of the plurality of users.

The refining comprises the application of one or more statistical methods, the one more statistical methods using information including responses of the plurality of users to at least one of the calibration stimuli and the testing media.

The one or more statistical methods includes mean squared error analysis.

The one or more statistical methods includes non-linear least squares fitting.

The one or more statistical methods includes ridge regression.

The machine-readable medium of an embodiment comprises using the refined coefficients to update the at least one expected response.

The machine-readable medium of an embodiment comprises computing an aggregate response to the testing media across all users of the plurality of users, the aggregate response including information of at least one of the coefficients and the revised coefficients.

The machine-readable medium of an embodiment comprises using the aggregate response to update the calibration stimuli.

The expected responses to the calibration stimuli are empirically determined using at least one of population data, previous test data, surveys of the plurality of users, and expert opinions from an industry relevant to the testing.

The expected responses comprise the at least one expected response.

The machine-readable medium of an embodiment comprises using training media to assess and minimize bias in the responses of the plurality of users to the testing media by analyzing responses of the plurality of users to the training media, the training media including the calibration stimuli.

The training media includes media analogous to the testing media but not used as the testing media, the training media including the calibration stimuli.

The training media are presented to the plurality of users before the testing.

The training media are presented to the plurality of users after the testing.

The machine-readable medium of an embodiment comprises explaining the amount of variation.

The explaining includes using Principle Component Analysis.

The explaining includes using Linear Discriminant Analysis.

The explaining includes using Support Vector Machines.

The explaining includes using Locally Linear Embedding.

The data features comprise time domain features including EEG data, heartbeat data, eye movement data, eye blink data, and body movement data.

The collecting time domain features comprises measuring one or more of mean, minimum, and maximum amplitude of at least one of the time domain features in a specified interval and time to minimum or maximum amplitude of at least one of the time domain features.

The data features comprise frequency domain features of EEG, heartbeat, eye movement, eye blink, and body movement data.

The collecting frequency domain features comprises measuring one or more of mean, minimum, maximum, mode of frequency in a specified interval, time to minimum or maximum, ratios of arbitrary numbers of arbitrarily-defined frequency bins, sums of arbitrary numbers of arbitrarily-defined frequency bins, differences of arbitrary numbers of arbitrarily-defined frequency bins and products of arbitrary numbers of arbitrarily-defined frequency bins.

The machine-readable medium of an embodiment comprises inputting state and response predictions generated by the testing process into a Neuroscience-based decision support system (NSDSS), wherein the testing process comprises one or more of the defining calibration stimuli, the defining the data features, the identifying the set of data features, the iteratively reducing the set of date features, the testing, the determining the coefficients, the refining the coefficients, and the computing an aggregate response.

The NSDSS provides market research and product design metrics and iteratively provides information to the testing process that improves predictive performance of the testing process.

The machine-readable medium of an embodiment comprises combining the state and response predictions with expert information to generate an error function used to provide performance metrics for the testing process, wherein the expert information includes proprietary information of at least one of the provider of the testing process and the party commissioning the testing process.

Embodiments described herein include a system comprising a plurality of sensors attached to a plurality of subjects, a processor coupled to the plurality of sensors, the processor receiving biometric response data of the plurality of subjects, and an application executing on the processor and decoding a subject response to marketing media by defining calibration stimuli that produce at least one expected response, defining data features for assessing one or more states of a plurality of subjects using at least one of the calibration stimuli and the at least one expected response, identifying a set of data features based on a first correlation between the set of data features and the at least one expected response, and iteratively reducing the set of data features based upon an amount of variation explained by the reduced set of data features and a second correlation between the reduced set of data features and the at least one expected response.

The system of an embodiment comprises testing responses of each subject of the plurality of subjects to testing media, the one or more states of the plurality of subjects including the responses.

The system of an embodiment comprises determining coefficients of each data feature of the reduced set of data features through the testing.

The testing media include television commercials, print ads, web-based ads, website navigation, web-based shopping, virtual in-store shopping, and live in-store shopping.

The calibration stimuli include sounds, still images, videos and other media relevant to the testing media.

The system of an embodiment comprises refining the coefficients for each subject of the plurality of subjects.

The refining comprises the application of one or more statistical methods, the one more statistical methods using information including responses of the plurality of subjects to at least one of the calibration stimuli and the testing media.

The one or more statistical methods includes mean squared error analysis.

The one or more statistical methods includes non-linear least squares fitting.

The one or more statistical methods includes ridge regression.

The system of an embodiment comprises using the refined coefficients to update the at least one expected response.

The system of an embodiment comprises computing an aggregate response to the testing media across all subjects of the plurality of subjects, the aggregate response including information of at least one of the coefficients and the revised coefficients.

The system of an embodiment comprises using the aggregate response to update the calibration stimuli.

Expected responses to the calibration stimuli are empirically determined using at least one of population data, previous test data, surveys of the plurality of subjects, and expert opinions from an industry relevant to the testing.

The expected responses comprise the at least one expected response.

The system of an embodiment comprises using training media to assess and minimize bias in the responses of the plurality of subjects to the testing media by analyzing responses of the plurality of subjects to the training media, the training media including the calibration stimuli.

The training media include media analogous to the testing media but not used as the testing media, the training media including the calibration stimuli.

The training media are presented to the plurality of subjects before the testing.

The training media are presented to the plurality of subjects after the testing.

The system of an embodiment comprises explaining the amount of variation.

The explaining includes using Principle Component Analysis.

The explaining includes using Linear Discriminant Analysis.

The explaining includes using Support Vector Machines.

The explaining includes using Locally Linear Embedding.

The data features comprise time domain features including EEG data, heartbeat data, eye movement data, eye blink data, and body movement data.

Collecting time domain features comprises measuring one or more of mean, minimum, and maximum amplitude of at least one of the time domain features in a specified interval and time to minimum or maximum amplitude of at least one of the time domain features.

The data features comprise frequency domain features of EEG, heartbeat, eye movement, eye blink, and body movement data.

Collecting frequency domain features comprises measuring one or more of mean, minimum, maximum, mode of frequency in a specified interval, time to minimum or maximum, ratios of arbitrary numbers of arbitrarily-defined frequency bins, sums of arbitrary numbers of arbitrarily-defined frequency bins, differences of arbitrary numbers of arbitrarily-defined frequency bins and products of arbitrary numbers of arbitrarily-defined frequency bins.

The system of an embodiment comprises comprising inputting state and response predictions generated by the testing process into a Neuroscience-based decision support system (NSDSS), wherein the testing process comprises one or more of the defining calibration stimuli, the defining the data features, the identifying the set of data features, the iteratively reducing the set of date features, the testing, the determining the coefficients, the refining the coefficients, and the computing an aggregate response.

The NSDSS providing market research and product design metrics and iteratively providing information to the testing process that improves predictive performance of the testing process.

The system of an embodiment comprises combining the state and response predictions with expert information to generate an error function used to provide performance metrics for the testing process, wherein the expert information includes proprietary information of at least one of the provider of the testing process and the party commissioning the testing process.

The systems and methods described herein can be used in conjunction with the systems and methods described in one or more of the following U.S. patent application numbers owned by EmSense Corporation, each of which is incorporated by reference in its entirety herein: Ser. No. 11/804,517, filed May 17, 2007; Ser. No. 11/804,555, filed May 17, 2007; Ser. No. 11/779,814, filed Jul. 18, 2007; Ser. No. 11/500,678, filed Aug. 8, 2006; Ser. No. 11/845,993, filed Aug. 28, 2007; Ser. No. 11/835,634, filed Aug. 8, 2007; Ser. No. 11/846,068, filed Aug. 28, 2007; Ser. No. 12/180,510, filed Jul. 25, 2008; Ser. No. 12/206,676, filed Sep. 8, 2008; Ser. No. 12/206,700, filed Sep. 8, 2008; Ser. No. 12/206,702, filed Sep. 8, 2008; Ser. No. 12/244,737, filed Oct. 2, 2008; Ser. No. 12/244,748, filed Oct. 2, 2008; Ser. No. 12/263,331, filed Oct. 31, 2008; Ser. No. 12/244,751, filed Oct. 2, 2008; Ser. No. 12/244,752, filed Oct. 2, 2008; Ser. No. 12/263,350, filed Oct. 31, 2008; Ser. No. 11/430,555, filed May 9, 2006; Ser. No. 11/681,265, filed Mar. 2, 2007; Ser. No. 11/852,189, filed Sep. 7, 2007; Ser. No. 11/959,399, filed Dec. 18, 2007; Ser. No. 12/326,016, filed Dec. 1, 2008; 61/225,186, filed Jul. 13, 2009.

The components described herein can be components of a single system, multiple systems, and/or geographically separate systems. The components can also be subcomponents or subsystems of a single system, multiple systems, and/or geographically separate systems. The components can be coupled to one or more other components (not shown) of a host system or a system coupled to the host system.

The components of an embodiment include and/or run under and/or in association with a processing system. The processing system includes any collection of processor-based devices or computing devices operating together, or components of processing systems or devices, as is known in the art. For example, the processing system can include one or more of a portable computer, portable communication device operating in a communication network, and/or a network server. The portable computer can be any of a number and/or combination of devices selected from among personal computers, cellular telephones, personal digital assistants, portable computing devices, and portable communication devices, but is not so limited. The processing system can include components within a larger computer system.

The processing system of an embodiment includes at least one processor and at least one memory device or subsystem. The processing system can also include or be coupled to at least one database. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components, and/or provided by some combination of algorithms. The methods described herein can be implemented in one or more of software algorithm(s), programs, firmware, hardware, components, circuitry, in any combination.

Components of an embodiment can be located together or in separate locations. Communication paths couple the electrodes and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

Aspects of the components and corresponding systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the components and corresponding systems and methods include: microcontrollers with memory (such as electronically erasable programmable read only memory (EEPROM)), embedded microprocessors, firmware, software, etc. Furthermore, aspects of the components and corresponding systems and methods may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments is not intended to be exhaustive or to limit the systems and methods to the precise forms disclosed. While specific embodiments and examples are described herein for illustrative purposes, various equivalent modifications are possible within the scope of the systems and methods, as those skilled in the relevant art will recognize. The teachings of the components provided herein can be applied to other systems and methods, not only for the systems and methods described above.

The elements and acts of the various embodiments described above can be combined to provide further embodiments. These and other changes can be made to the electrodes in light of the above detailed description.

What is claimed is:

1. A method running on a processor for decoding user response to marketing media, the method comprising:
defining calibration stimuli that produce at least one expected response;
defining data features for assessing one or more states of a plurality of users using at least one of the calibration stimuli and the at least one expected response;
identifying a set of data features based on a first correlation between the set of data features and the at least one expected response; and
iteratively reducing the set of data features based upon an amount of variation explained by the reduced set of data features and a second correlation between the reduced set of data features and the at least one expected response.

2. The method of claim 1, comprising testing responses of each user of the plurality of users to testing media, the one or more states of the plurality of users including the responses.

3. The method of claim 2, determining coefficients of each data feature of the reduced set of data features through the testing.

4. The method of claim 3, the testing media including television commercials, print ads, web-based ads, website navigation, web-based shopping, virtual in-store shopping, and live in-store shopping.

5. The method of claim 4, the calibration stimuli including sounds, still images, videos and other media relevant to the testing media.

6. The method of claim 5, refining the coefficients for each user of the plurality of users.

7. The method of claim 6, wherein the refining comprises the application of one or more statistical methods, the one more statistical methods using information including responses of the plurality of users to at least one of the calibration stimuli and the testing media.

8. The method of claim 7, wherein the one or more statistical methods includes mean squared error analysis.

9. The method of claim 7, wherein the one or more statistical methods includes non-linear least squares fitting.

10. The method of claim 7, wherein the one or more statistical methods includes ridge regression.

11. The method of claim 7, comprising using the refined coefficients to update the at least one expected response.

12. The method of claim 11, comprising computing an aggregate response to the testing media across all users of the plurality of users, the aggregate response including information of at least one of the coefficients and the revised coefficients.

13. The method of claim 12, comprising using the aggregate response to update the calibration stimuli.

14. The method of claim 13, wherein expected responses to the calibration stimuli are empirically determined using at least one of population data, previous test data, surveys of the plurality of users, and expert opinions from an industry relevant to the testing.

15. The method of claim 14, wherein the expected responses comprise the at least one expected response.

16. The method of claim 15, comprising using training media to assess and minimize bias in the responses of the plurality of users to the testing media by analyzing responses of the plurality of users to the training media, the training media including the calibration stimuli.

17. The method of claim 16, the training media including media analogous to the testing media but not used as the testing media, the training media including the calibration stimuli.

18. The method of claim 17, wherein the training media are presented to the plurality of users before the testing.

19. The method of claim 18, wherein the training media are presented to the plurality of users after the testing.

20. The method of claim 19, comprising explaining the amount of variation.

21. The method of claim 20, wherein the explaining includes using Principle Component Analysis.

22. The method of claim 20, wherein the explaining includes using Linear Discriminant Analysis.

23. The method of claim 20, wherein the explaining includes using Support Vector Machines.

24. The method of claim 20, wherein the explaining includes using Locally Linear Embedding.

25. The method of claim 20, wherein the data features comprise time domain features including EEG data, heartbeat data, eye movement data, eye blink data, and body movement data.

26. The method of claim 25, wherein collecting time domain features comprises measuring one or more of mean, minimum, and maximum amplitude of at least one of the time domain features in a specified interval and time to minimum or maximum amplitude of at least one of the time domain features.

27. The method of claim 26, wherein the data features comprise frequency domain features of EEG, heartbeat, eye movement, eye blink, and body movement data.

28. The method of claim 27, wherein collecting frequency domain features comprises measuring one or more of mean, minimum, maximum, mode of frequency in a specified interval, time to minimum or maximum, ratios of arbitrary numbers of arbitrarily-defined frequency bins, sums of arbitrary numbers of arbitrarily-defined frequency bins, differences of arbitrary numbers of arbitrarily-defined frequency bins and products of arbitrary numbers of arbitrarily-defined frequency bins.

29. The method of claim 28, comprising inputting state and response predictions generated by the testing process into a Neuroscience-based decision support system (NSDSS), wherein the testing process comprises one or more of the defining calibration stimuli, the defining the data features, the identifying the set of data features, the iteratively reducing the set of date features, the testing, the determining the coefficients, the refining the coefficients, and the computing an aggregate response.

30. The method of claim 29, the NSDSS providing market research and product design metrics and iteratively providing information to the testing process that improves predictive performance of the testing process.

31. The method of claim 30, comprising combining the state and response predictions with expert information to generate an error function used to provide performance metrics for the testing process, wherein the expert information includes proprietary information of at least one of the provider of the testing process and the party commissioning the testing process.

32. A machine-readable medium including executable instructions which, when executed in a processing system, decodes user response to marketing media by:
defining calibration stimuli that produce at least one expected response;
defining data features for assessing one or more states of a plurality of users using at least one of the calibration stimuli and the at least one expected response;
identifying a set of data features based on a first correlation between the set of data features and the at least one expected response; and
iteratively reducing the set of data features based upon an amount of variation explained by the reduced set of data features and a second correlation between the reduced set of data features and the at least one expected response.

33. The machine-readable medium of claim 32, comprising testing responses of each user of the plurality of users to testing media, the one or more states of the plurality of users including the responses.

34. The machine-readable medium of claim 33, determining coefficients of each data feature of the reduced set of data features through the testing.

35. The machine-readable medium of claim 34, the testing media including television commercials, print ads, web-based ads, website navigation, web-based shopping, virtual in-store shopping, and live in-store shopping.

36. The machine-readable medium of claim 35, the calibration stimuli including sounds, still images, videos and other media relevant to the testing media.

37. The machine-readable medium of claim 36, refining the coefficients for each user of the plurality of users.

38. The machine-readable medium of claim 37, wherein the refining comprises the application of one or more statistical methods, the one more statistical methods using information including responses of the plurality of users to at least one of the calibration stimuli and the testing media.

39. The machine-readable medium of claim 38, wherein the one or more statistical methods includes mean squared error analysis.

40. The machine-readable medium of claim 38, wherein the one or more statistical methods includes non-linear least squares fitting.

41. The machine-readable medium of claim 38, wherein the one or more statistical methods includes ridge regression.

42. The machine-readable medium of claim 38, comprising using the refined coefficients to update the at least one expected response.

43. The machine-readable medium of claim 42, comprising computing an aggregate response to the testing media across all users of the plurality of users, the aggregate response including information of at least one of the coefficients and the revised coefficients.

44. The machine-readable medium of claim 43, comprising using the aggregate response to update the calibration stimuli.

45. The machine-readable medium of claim 44, wherein expected responses to the calibration stimuli are empirically determined using at least one of population data, previous test data, surveys of the plurality of users, and expert opinions from an industry relevant to the testing.

46. The machine-readable medium of claim 45, wherein the expected responses comprise the at least one expected response.

47. The machine-readable medium of claim 46, comprising using training media to assess and minimize bias in the responses of the plurality of users to the testing media by analyzing responses of the plurality of users to the training media, the training media including the calibration stimuli.

48. The machine-readable medium of claim 47, the training media including media analogous to the testing media but not used as the testing media, the training media including the calibration stimuli.

49. The machine-readable medium of claim 48, wherein the training media are presented to the plurality of users before the testing.

50. The machine-readable medium of claim 49, wherein the training media are presented to the plurality of users after the testing.

51. The machine-readable medium of claim 50, comprising explaining the amount of variation.

52. The machine-readable medium of claim 51, wherein the explaining includes using Principle Component Analysis.

53. The machine-readable medium of claim 51, wherein the explaining includes using Linear Discriminant Analysis.

54. The machine-readable medium of claim 51, wherein the explaining includes using Support Vector Machines.

55. The machine-readable medium of claim 51, wherein the explaining includes using Locally Linear Embedding.

56. The machine-readable medium of claim 51, wherein the data features comprise time domain features including EEG data, heartbeat data, eye movement data, eye blink data, and body movement data.

57. The machine-readable medium of claim 56, wherein collecting time domain features comprises measuring one or more of mean, minimum, and maximum amplitude of at least one of the time domain features in a specified interval and time to minimum or maximum amplitude of at least one of the time domain features.

58. The machine-readable medium of claim 57, wherein the data features comprise frequency domain features of EEG, heartbeat, eye movement, eye blink, and body movement data.

59. The machine-readable medium of claim 58, wherein collecting frequency domain features comprises measuring one or more of mean, minimum, maximum, mode of frequency in a specified interval, time to minimum or maximum, ratios of arbitrary numbers of arbitrarily-defined frequency bins, sums of arbitrary numbers of arbitrarily-defined frequency bins, differences of arbitrary numbers of arbitrarily-defined frequency bins and products of arbitrary numbers of arbitrarily-defined frequency bins.

60. The machine-readable medium of claim 59, comprising inputting state and response predictions generated by the testing process into a Neuroscience-based decision support system (NSDSS), wherein the testing process comprises one or more of the defining calibration stimuli, the defining the data features, the identifying the set of data features, the iteratively reducing the set of date features, the testing, the determining the coefficients, the refining the coefficients, and the computing an aggregate response.

61. The machine-readable medium of claim 60, the NSDSS providing market research and product design metrics and iteratively providing information to the testing process that improves predictive performance of the testing process.

62. The machine-readable medium of claim 61, comprising combining the state and response predictions with expert information to generate an error function used to provide performance metrics for the testing process, wherein the expert information includes proprietary information of at least one of the provider of the testing process and the party commissioning the testing process.

63. A system comprising:
a plurality of sensors attached to a plurality of subjects;
a processor coupled to the plurality of sensors, the processor receiving biometric response data of the plurality of subjects; and
an application executing on the processor and decoding a subject response to marketing media by defining calibration stimuli that produce at least one expected response, defining data features for assessing one or more states of a plurality of subjects using at least one of the calibration stimuli and the at least one expected response, identifying a set of data features based on a first correlation between the set of data features and the at least one expected response, and iteratively reducing the set of data features based upon an amount of variation explained by the reduced set of data features and a second correlation between the reduced set of data features and the at least one expected response.

64. The system of claim 63, comprising testing responses of each subject of the plurality of subjects to testing media, the one or more states of the plurality of subjects including the responses.

65. The system of claim 64, determining coefficients of each data feature of the reduced set of data features through the testing.

66. The system of claim 65, the testing media including television commercials, print ads, web-based ads, website navigation, web-based shopping, virtual in-store shopping, and live in-store shopping.

67. The system of claim 66, the calibration stimuli including sounds, still images, videos and other media relevant to the testing media.

68. The system of claim 67, refining the coefficients for each subject of the plurality of subjects.

69. The system of claim 68, wherein the refining comprises the application of one or more statistical methods, the one more statistical methods using information including responses of the plurality of subjects to at least one of the calibration stimuli and the testing media.

70. The system of claim 69, wherein the one or more statistical methods includes mean squared error analysis.

71. The system of claim 69, wherein the one or more statistical methods includes non-linear least squares fitting.

72. The system of claim 69, wherein the one or more statistical methods includes ridge regression.

73. The system of claim 69, comprising using the refined coefficients to update the at least one expected response.

74. The system of claim 73, comprising computing an aggregate response to the testing media across all subjects of the plurality of subjects, the aggregate response including information of at least one of the coefficients and the revised coefficients.

75. The system of claim 74, comprising using the aggregate response to update the calibration stimuli.

76. The system of claim 75, wherein expected responses to the calibration stimuli are empirically determined using at least one of population data, previous test data, surveys of the plurality of subjects, and expert opinions from an industry relevant to the testing.

77. The system of claim 76, wherein the expected responses comprise the at least one expected response.

78. The system of claim 77, comprising using training media to assess and minimize bias in the responses of the plurality of subjects to the testing media by analyzing responses of the plurality of subjects to the training media, the training media including the calibration stimuli.

79. The system of claim 78, the training media including media analogous to the testing media but not used as the testing media, the training media including the calibration stimuli.

80. The system of claim 79, wherein the training media are presented to the plurality of subjects before the testing.

81. The system of claim 80, wherein the training media are presented to the plurality of subjects after the testing.

82. The system of claim 81, comprising explaining the amount of variation.

83. The system of claim 82, wherein the explaining includes using Principle Component Analysis.

84. The system of claim 82, wherein the explaining includes using Linear Discriminant Analysis.

85. The system of claim 82, wherein the explaining includes using Support Vector Machines.

86. The system of claim 82, wherein the explaining includes using Locally Linear Embedding.

87. The system of claim 82, wherein the data features comprise time domain features including EEG data, heartbeat data, eye movement data, eye blink data, and body movement data.

88. The system of claim 87, wherein collecting time domain features comprises measuring one or more of mean, minimum, and maximum amplitude of at least one of the time domain features in a specified interval and time to minimum or maximum amplitude of at least one of the time domain features.

89. The system of claim 88, wherein the data features comprise frequency domain features of EEG, heartbeat, eye movement, eye blink, and body movement data.

90. The system of claim 89, wherein collecting frequency domain features comprises measuring one or more of mean, minimum, maximum, mode of frequency in a specified interval, time to minimum or maximum, ratios of arbitrary numbers of arbitrarily-defined frequency bins, sums of arbitrary numbers of arbitrarily-defined frequency bins, differences of arbitrary numbers of arbitrarily-defined frequency bins and products of arbitrary numbers of arbitrarily-defined frequency bins.

91. The system of claim 90, comprising inputting state and response predictions generated by the testing process into a Neuroscience-based decision support system (NSDSS), wherein the testing process comprises one or more of the defining calibration stimuli, the defining the data features, the identifying the set of data features, the iteratively reducing the set of date features, the testing, the determining the coefficients, the refining the coefficients, and the computing an aggregate response.

92. The system of claim 91, the NSDSS providing market research and product design metrics and iteratively providing information to the testing process that improves predictive performance of the testing process.

93. The system of claim 92, comprising combining the state and response predictions with expert information to generate an error function used to provide performance metrics for the testing process, wherein the expert information includes proprietary information of at least one of the provider of the testing process and the party commissioning the testing process.
